(19) United States
(12) Patent Application Publication
(10) Pub. No.: US 2006/0206806 A1
(43) Pub. Date: Sep. 14, 2006

(54) Text summarization

(75) Inventors: Ke Song Han, Shanghai (CN); Fang Chen, Peakhurst Heights (AU); Gui Lin Chen, Shanghai (CN)

Correspondence Address: MOTOROLA INC, 600 NORTH US HIGHWAY 45, ROOM AS437, LIBERTYVILLE, IL, 60048-5343, US

(73) Assignee: MOTOROLA, INC.

(21) Appl. No.: 11/416,978

(22) Filed: May 3, 2006

(30) Foreign Application Priority Data
Nov. 4, 2004 (WO) PCT/US04/36896

(51) Int. Cl. G06F 17/00

(52) U.S. Cl. 715/513

(57) ABSTRACT

A method for summarizing text (20), comprising evaluating (24) selected words of the text according to predetermined criteria to provide word score values for each of the selected words. Thew method then provides for calculating (25) for each of the selected words a word weighted score that is dependent on the word score values and a number of occurrences of each of the selected words. Thereafter a step (26) of scoring sentences of the text to determine a sentence weighted score for the sentences is conducted. The sentence weighted score depends on sentence type and a combined word weighted score for words in the sentence. The method then provides for selecting (27) sentences to provide a summary of the text, the selecting being dependent on the sentence weighted score of the sentences.

### FIELD OF THE INVENTION

This invention concerns automatic text summarization of documents. The invention is particularly useful for, but not necessarily limited to, summarizing text received by a radio communications port or memory module associated with an electronic device.

### BACKGROUND OF THE INVENTION

Each day individuals are exposed to text in a document such as newspapers, technical papers, e-mails, technical reports and general news. The volume of literature published annually in a specific field is generally far too large for an individual to read and assimilate. Ideally, a title and abstract should convey to the reader the main themes of the document and consequently whether the complete document is of any relevance. These document sections that are highly rich in content can be misleading and inaccurate. Hence, there is a need to provide automatic document summary generation tools. Having a summary of a document allows the reader to determine whether that document is of interest, and hence, reading more of the document might be desirable. Conversely, reading the summary of a document could suffice to sufficiently inform the reader about the document, or instead, could indicate to the reader that the particular document is not of interest.

### SUMMARY OF THE INVENTION

According to one aspect of the invention, there is provided a method for summarizing text, comprising the steps of:
evaluating selected words of the text according to predetermined criteria to provide word score values for each of the selected words;
calculating for each of the selected words a word weighted score that is dependent on the word score values and a number of occurrences of each of the selected words;
scoring sentences of the text to determine a sentence weighted score for the sentences, the sentence weighted score depending on sentence type and a combined word weighted score for words therein; and
selecting at least one of the sentences to provide a summary of the text, the selecting being dependent on the sentence weighted score of at least some of the sentences.

Suitably, the sentence type is dependent on predetermined indicator words and phrases. The sentence type may be dependent on the case of a word or the sentence type can be from a group comprising:
a title sentence,
a supplementary title sentence,
sub-title without any symbol,
first sentence in a paragraph,
second sentence in a paragraph,
middle sentences in a paragraph, and
last sentence in a paragraph.

Preferably, the predetermined criteria may include word length or a type of sentence the word appears in, or a word part-of-speech, or a word inherent value, or a words syntax function value in the sentence.

Suitably, the word weighted score W is determined by the formula:
W=W_{L}×W_{POS}×W_{type}×Wᵥₐₗᵤₑ×W_{RIS}
given that W is a word's weighted score for a single occurrence in the text, W_{L} is a word length value, W_{POS} is a word part-of-speech value, W_{type} is word sentence type value which the word appears, Wᵥₐₗᵤₑ is a word inherent value and W_{RIS} is a word syntax function value in the sentence in which the word appears.

Preferably, the following non-linear formula can be used to determine the word weighted score of a word that has more than one occurrence:
W(n+1)=W(n)+1/(n+1)×Wⁿ⁺¹ where W(1)=W
given that W(n+1) is the word's total weight when it has n+1 occurrences, W(n) is the word's accumulated weight when it has a total of n occurrences, and Wⁿ⁺¹ is the weight of the individual word at its (n+1)th occurrence.

Suitably, the following formula is used to provide the sentence weighted score:
WS=ΣW(wᵢ)×S(type)/S(len)
where WS is the sentence weighted score of a sentence, ΣW(wᵢ) is the sum of all the word weighted scores in this sentence, and S(len) is another weighting factor related to sentence length.

Preferably, the step of selecting sentences for the summary involves selecting only sentences of a sentence length between a minimum sentence length threshold value and a maximum sentence length threshold value, the sentence length being determined by a number of words therein.

Suitably, selecting at least one of the sentences can be based on selecting a proportion of sentences ordered according to their sentence weighted score. In one alternative, the selecting at least one of the sentences can be based on selecting sentences having their sentence weighted scores above a threshold value.

In a second aspect the invention is a text summarizing system to perform the method described above, the system comprising:
memory to receive a document and store a program.
a processor to perform the method on the document in memory using the program.

In a third aspect the invention is an engine embedded into a browser to perform the method described above, the system comprising:
memory to receive a document and store a program.
a processor to perform the method on the document in memory using the program.

In a fourth as aspect the invention is an electronics communication device to perform the method described above, the system comprising:
memory to receive a document and store a program.
a processor to perform the method on the document in memory using the program.

The electronic communication device may include a mobile phone or personal digital assistant.

### BRIEF DESCRIPTION OF THE DRAWINGS

Examples of the invention will now be described with reference to the accompanying drawings, in which:

FIG. 1 is a block diagram of an electronic device; and

FIG. 2 is a flow diagram illustrating a method for summarizing text that may be performed on the device of FIG. 1.

### DETAILED DESCRIPTION OF THE PREFERRED EMBODIMENT OF THE INVENTION

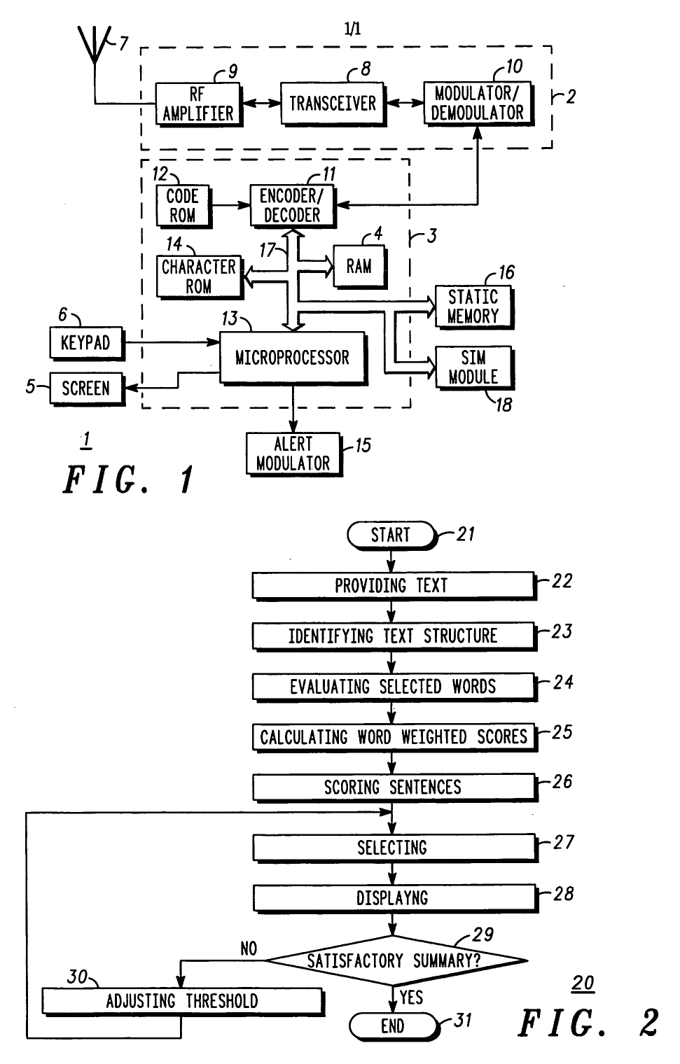

In the drawings, like numerals are used to indicate like elements throughout. With reference to FIG. 1, an electronic device in the form of a radio telephone 1 comprises a radio frequency communications unit 2 coupled to be in communication with a processor 3. An input interface in the form of a screen 5 and a keypad 6 are also coupled to be in communication with the processor 3.

The processor 3 includes an encoder/decoder 11 with an associated Read Only Memory (ROM) 12 storing data for encoding and decoding voice or other signals that may be transmitted or received by the radio telephone 1. The processor 3 also includes a micro-processor 13 coupled, by a common data and address bus 17, to the encoder/decoder 11 and an associated character Read Only Memory (ROM) 14, a Random Access Memory (RAM) 4, static programmable memory 16 and a removable SIM module 18. The static programmable memory 16 and SIM module 18 each can store, amongst other things, selected incoming text messages and a telephone book database TDb.

The micro-processor 13 has ports for coupling to the keypad 6, the screen 5 and an alert module 15 that typically contains a speaker, vibrator motor and associated drivers. The character Read Only Memory 14 stores code for decoding or encoding text messages that may be received by the communication unit 2 or input at the keypad 6. In this embodiment the character Read Only Memory 14 also stores operating code (OC) for micro-processor 13 and code for performing text summarization as described below with reference to FIG. 2.

The radio frequency communications unit 2 is a combined receiver and transmitter having a common antenna 7. The communications unit 2 has a transceiver 8 coupled to antenna 7 via a radio frequency amplifier 9. The transceiver 8 is also coupled to a combined modulator/demodulator 10 that couples the communications unit 2 to the processor 3.

Referring now to FIG. 2, there is illustrated a method 20 for summarizing text. The method 20 is typically invoked, at a start step 21, by a user entering a command at the keypad 6. The method 20 then includes a step of providing text 22 that may be provided by a user inserting a memory module containing text into the sim module 18 or by the device 1 receiving a text message via the radio frequency unit 2 that is subsequently stored in the static memory 16. It should be noted that the text can be received by other means including downloading from the internet (via a port not shown). After of the text is provided, typically in the form of an electronic document, appropriate resources may be flagged for use, these resources being stored in ROM 14. For instance, for Chinese text a Chinese word lexicon and a Chinese part-of-speech (POS) dictionary may be flagged for use.

The method 20 then performs a step of identifying text structure 23 that is essentially a pre-processing stage where the text is prepared for automatic summarization. All the processing for summarisation is performed by the micro-processor 13 using code stored in the character Read Only Memory 14. The text will generally be written in an author's particular style and with the author's preferred layout. For example, one writer may like to insert a blank line between two paragraphs, while another may add four blank spaces at the beginning of each paragraph. Also, there are special problems associated with Chinese text since it is based on the double-byte-character set (DBCS). Most characters in a Chinese document are stored using two bytes, but there will usually be many single byte symbols, such as English letters, numbers, and punctuations, etc. Punctuation, for instance a stop ‘.’ creates additional problems. The stop could be a full stop of the single-byte-character set (SBC) which can identify the end of a sentence, so it should be transformed into “□”. But if it is a decimal symbol in a number string, or if it is a part of suspension points, it doesn't need further processing.

In step 23, the unnecessary spaces and blank lines are identified and deleted. This step 23 also generally involves determining an average length of a text line and the number of sentences. The text is also structurally analysed to identify its various parts, such as: title; subtitle; author; abstract; paragraph numbering; relative sentence numbering in a paragraph and in the complete text; and references.

The method 20 next performs a step of evaluating 24 selected words of the text according to predetermined criteria to provide word score values for each of the selected words. In this step 24 the words in the text are scored depending upon how likely they are to be useful in the summary. Also, Chinese words are subjected to segmentation that involves a coarse segmentation by word matching. Any ambiguity is processed using the well known Chinese character grouping of “right priority” and “high-frequency priority” (selecting frequently used character groups). Then person and place names are processed, since in Chinese text there can be a single surname and a double surname. Also, English words are stemmed that involves removing the variable word endings such as “ing” and “ed”. After segmentation or stemming a score value is allocated to each selected word in the text, depending on the following criteria:
1. A word length value W_{L} (where an integer value of 1 is given per character forming the word when the word is represented by alphanumeric characters, the word length value being the square root (SQR) of the integer value; and when the text is in Chinese characters a default word length value of 1 is allocated); hence the word “dog” has a word length value of SQR(3), the word “begin” has a word length value of SQR(5) and the word “iterative” has a word length value of 3.
2. A word part-of-speech value W_{POS} (noun=1.2, verb=1.3, adjective=1.1; pronoun=1.1; others=0.5).
3. A word sentence type value W_{type} or rank of the type of sentence the word appears in or, if appropriate, an overriding rank for the word. A word is classified depending on the rank of the sentence it is in. There are 14 types for W_{type}, they are:
   word in the title=14
   word in vice title=13
   word in text's abstract=12
   word in subtitle with no symbol=11
   word in first level subtitle=10
   word in second level subtitle=9
   word in third level subtitle=8
   word in fourth level subtitle=7
   word in the first sentence of a paragraph=6
   word in the second sentence of a paragraph=5
   word in a last sentence of a paragraph=4
   word in middle sentences of a paragraph=3
   word in independent sentence=2
   word in reference article=1
Alternatively, an overriding rank (value of 14) for the word is selected when it is identified as a ‘subject indicative’ word or a ‘exemplitive’ word. For instance, a subject indicative words are “This text”, “In a word”, “All in all”, “Mainly introduce”, “Mainly research”, “Mainly analyze”, “highly commend”, “particularly point out”, “Unanimously think”, “intensively accuse” and “Unanimously overpass”. Examples of exemplitive words are “for example”, “for instance”, “instance”, “give an example” and “example”.
4. A word inherent value Wᵥₐₗᵤₑ (values of 0, 1 or 2). Different words have different inherent importance depending on historical, geographical or other factors. For example, there are two Chinese words for a hard disk. One is mainly used in China mainland, while the other is mainly used in Hong Kong and Taiwan, so these two words have different values for the geographical reason. Also there may be two words with the same meaning, but one is rarely used, so these two words have different values for a historical reason. The word's inherent value is determined by experience and stored in the dictionary, form where it can be retrieved.
5. A word syntax function value W_{RIS} in sentence. For instance, subjective or objective or predictive words receive a value of 2; complimentary words receive a value of 1.

After the step of evaluating 24 a step of calculating 25 is effected for calculating for each of the selected words a word weighted score that is dependent on the word score values and a frequency of occurrence of each of the selected words. The actual word weighted scores W¹ for the selected words are determined by a non-linear formula is as follows:
W=W_{L}×W_{POS}×W_{type}×Wᵥₐₗᵤₑ×W_{RIS}

When the word has more than 1 occurrence, the word weighted scores are calculated as follows:
W(n+1)=W(n)+1/(n+1)×Wⁿ⁺¹
to accumulate the weight, where W(n+1) is a word's total weighted score when it has n+1 occurrences, W(n) is a word's accumulated weighted score when it has a total of n occurrences, Wⁿ⁺¹ is the individual word weighted score at the (n+1)th occurrence, and W(1) is taken as W¹.

In a linear weighting system the weighting is multiplied by the frequency occurrence. For example, if a word “Clone” appears 5 times, it has an inherent value 3, then it will be given a value: 5*3=15. In contrast, this non-linear approach to frequency weighting, when W¹=3, W²=3, W³=3, W⁴=5.5 and W⁵=7.375, results in the accumulated word weighted weight of the word W as:
W(1)=3
W(2)=3+½*3=4.5
W(3)=4.5+⅓*3=5.5
W(4)=5.5+¼*5.5=6.875
W(5)=6.875+⅕*6.875=8.25

After the step of calculating 25 a scoring sentences step 26 provides for scoring sentences of the text to determine a sentence weighted score for the sentences, the sentence weighted score depending at least on sentence type value S(type) and a combined word weighted score of words in the sentence. Default sentence type values S(type) range for 14 to 1 as illustrated in table 1 below.

TABLE 1
Default Sentence Type value

| | Default Sentence | |
|---|---|---|
| Macro Name | Type Value DSTV | Rank |
| MAIN_TITLE | 14 | A title sentence |
| VICE_TITLE | 13 | A supplementary title sentence |
| SYMBOL_LESS_TITLE | 12 | Sub-title without any symbol |
| FIRST_LEVEL_TITLE | 11 | First level sub-title |
| SECOND_LEVEL_TITLE | 10 | Second level sub-title |
| THIRD_LEVEL_TITLE | 9 | Third level sub-title |
| FOURTH_LEVEL_TITLE | 8 | Fourth level sub-title |
| ABSTRACT_SENTENCE | 7 | Sentence in author's abstraction |
| PARAGRAPH_FIRST_SENTENCE | 6 | First sentence in a paragraph |
| PARAGRAPH_SECOND_SENTENCE | 5 | Second sentence in a paragraph |
| PARAGRAPH_MIDDLE_SENTENCE | 4 | Middle sentences in a paragraph |
| PARAGRAPH_TAIL_SENTENCE | 3 | Last sentence in a paragraph |
| INDEPENDENT_SENTENC | 2 | Independent sentence |
| REFERENCE_SENTENCE | 1 | Sentence in reference |

Also, the sentence type values are is dependent on the case of a word. For upper case sentences the Default Sentence Type Value DSTV is multiplied by a Case Factor CF of unity, whereas for lower case sentences the Default Sentence Type Value DSTV is altered by a Case Factor of 0.9. Also, sentences containing any of a list of predetermined indicator words and phrases are affect the Default Sentence Type Value DSTV. For example, “In conclusion”, “this letter”, “results”, “summary”, “argue”, “propose”, “develop”, “attempt” are identified since these are most likely to be useful in the summary and are identified as indicator words. Hence, sentences with such indicator words have their Default Sentence Type Value DSTV is altered by an Indicator Word Factor IWF of 1.2, however sentences without such indicator words have an Indicator Word Factor IWF of unity.

Thus the sentence type value S(type)=DSTV*CF*IWF

In this step 26 a sentence is weighed in a non-linear fashion depending on the weight of the words in it, the sentence type value S(type) or rank and its length. The following formula is used to weigh a sentence:
WS=ΣW(wᵢ)×S(type)/S(len)
where WS is the sentence weighted score of a sentence, ΣW(wᵢ) is the sum of all the word weighted scores in this sentence, and S(len) is another weighting factor related to sentence length.

The sum of the word weighted scores takes account of each word's individual weight, and so takes account of whether the sentence contains subject indicative or exemplitive words. Experience tells us that if a sentence contains a subject indicative, this sentence has a larger probability to be a summary sentence than those don't have any subject indicative words. Analogously, the sentences contain subject exemplitive words usually have a smaller probability than those don't have any subject exemplitive words.

Statistical analysis of sentence length distributions in source text and in human prepared summaries was conducted on a corpus of documents. The longest sentence had 180 words. We found these two distributions to be very alike. A Minimum Mean-Square Error method was therefore used to process the relationship between sentence length and importance, and a cubic equation was derived to describe this relationship quantitatively.
S(len)=y, where y=ax³+bx²+cx+d
Where x is the length in words of a sentence. Also, using the longest sentence of 180 words, a 180 by 180 matrix X can be derived of elements (xᵢ,yᵢ). We therefore get Y=X·θ, in other words the following is obtained:

$$[ \begin{matrix}{y}_{1} \\ {y}_{2} \\ {y}_{3} \\ … \\ {y}_{180}\end{matrix} ] = [ \begin{matrix}{x}_{1}^{3} & {x}_{1}^{2} & {x}_{1}^{1} & 1 \\ {x}_{2}^{3} & {x}_{2}^{2} & {x}_{2}^{1} & 1 \\ {x}_{3}^{3} & {x}_{3}^{2} & {x}_{3}^{1} & 1 \\ … & … & … & … \\ {x}_{180}^{3} & {x}_{180}^{2} & {x}_{180}^{1} & 1\end{matrix} ] [ \begin{matrix}a \\ b \\ c \\ d\end{matrix} ]$$

Since it can be deduced that θ=[X^{T}X]⁻¹X^{T}Y, we can determine values the four parameters: a, b, c and d. These values are: a=0.0002; b=0.2127; c=4.9961; and D=6.8755.

After the scoring sentences step 26 a selecting step 27 provides for selecting sentences (candidate summary sentences) of the text to provide a summary of the text, the selecting being dependent on the sentence weighted score of at least some of the sentences. In this regard, before selecting candidate summary sentences, the sentences are typically sorted by their weight in descending order.

Sentences that are too short or too long tend not to be included in summaries. A Minimum Sentence Length threshold MST value of, say, 5 words is set for the shortest allowable sentence length and 50 words for a Minimum Sentence Length threshold LST value. Sentences outside this range are excluded from selection. In other words, the selecting step 27 provides for selecting only sentences of a sentence length between the Minimum Sentence Length Threshold MST value and the Maximum Sentence Length Threshold MST value, the sentence length being determined by a number of words therein.

Given a certain length L of the resulting summary, sentences Sᵢ are selected from a set of sentences S, to satisfy two conditions simultaneously:
|ΣL(Sᵢ)−L|=min
ΣW(Sᵢ)=max
where L(Sᵢ) relates to the length of Sᵢ, and W(Sᵢ) relates to the weight of Sᵢ.

An overall sentence weighted score can be calculated to order the sentences in order of selection. A default length L of summary is set to 30% of the original text document and the top 30% of the sentences are selected and concatenated to create a summary. In other words, the selecting provides for selecting a proportion of sentences ordered according to their sentence weighted score. In one alternative, the selecting provides for selecting sentences having their sentence weighted scores above a threshold value. The summary smoothed by standard known techniques and is then displayed at the screen 5 a displaying step 28 and at a test step 29 a user can decide if the summary is satisfactory by selecting relevant keys of keypad 6. If the summary is unsatisfactory the user may, at an adjusting parameters step 30, adjust the thresholds MST, LST, adjust the default length L of the summary and also change bias weightings of certain words. Also, different readers may have different interests in an article. The method 20 therefore automatically maintains a bias word list, and the user can add to or delete from the list prior to invoking the method 20 or at step 30.

After step 30 steps 27 and 28 are performed and the parameters may be adjusted again if at the test step 29 the summary is deemed unsatisfactory, otherwise the summary is selected as satisfactory (or a user terminates the method 20) at test step 29 and the summary can be stored in memory 16 before the method 20 terminates at an end step 31.

Advantageously, the present invention provides a useful method for efficiently summarizing text. It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

We claim:

1. A method for summarizing text, comprising the steps of:
evaluating selected words of the text according to predetermined criteria to provide word score values for each of the selected words;
calculating for each of the selected words a word weighted score that is dependent on the word score values and a number of occurrences of each of the selected words;
scoring sentences of the text to determine a sentence weighted score for the sentences, the sentence weighted score depending on sentence type and a combined word weighted score for words therein; and
selecting at least one of the sentences to provide a summary of the text, the selecting being dependent on the sentence weighted score of at least some of the sentences.

2. A method according to claim 1, characterized in that the sentence type is dependent on predetermined indicator words and phrases.

3. A method according to claim 1, characterized in that the sentence type is dependent on the case of a word.

4. A method according to claim 1, characterized in that sentence type is from a group comprising:
a title sentence,
a supplementary title sentence,
sub-title without any symbol,
first sentence in a paragraph,
second sentence in a paragraph,
middle sentences in a paragraph, and
last sentence in a paragraph.

5. A method according to claim 1, characterized in that the predetermined criteria includes word length.

6. A method according to claim 1, characterized in that the predetermined criteria includes a type of sentence the word appears in.

7. A method according to claim 1, characterized in that the predetermined criteria includes a word part-of-speech.

8. A method according to claim 1, characterized in that the predetermined criteria includes a word inherent value.

9. A method according to claim 1, characterized in that the predetermined criteria includes the words syntax function value in the sentence.

10. A method according to claim 1, characterized in that the word weighted score W is determined by the formula:
W=W_{L}×W_{POS}×W_{type}×Wᵥₐₗᵤₑ×W_{RIS}
given that W is a word's weighted score for a single occurrence in the text, W_{L} is a word length value, W_{POS} is a word part-of-speech value, W_{type} is word sentence type value which the word appears, Wᵥₐₗᵤₑ is a word inherent value and W_{RIS} is a word syntax function value in the sentence in which the word appears.

11. A method according to claim 10, characterized in that the following non-linear formula is used to determine the word weighted score of a word that has more than one occurrence:
W(n+1)=W(n)+1/(n+1)×Wⁿ⁺¹ where W(1)=W
given that W(n+1) is the word's total weight when it has n+1 occurrences, W(n) is the word's accumulated weight when it has a total of n occurrences, and Wⁿ⁺¹ is the weight of the individual word at its (n+1)th occurrence.

12. A method according to claim 11, characterized in that the following formula is used to provide the sentence weighted score:
WS=ΣW(wᵢ)×S(type)/S(len)
where WS is the sentence weighted score of a sentence, ΣW(wᵢ) is the sum of all the word weighted scores in this sentence, and S(len) is another weighting factor related to sentence length.

13. A method according to claim 1, characterized in that the step of selecting sentences for the summary involves selecting only sentences of a sentence length between a minimum sentence length threshold value and a maximum sentence length threshold value, the sentence length being determined by a number of words therein.

14. A method according to claim 1, characterized in that selecting at least one of the sentences is based on selecting a proportion of sentences ordered according to their sentence weighted score.

15. A method according to claim 1, characterized in that selecting at least one of the sentences is based on selecting sentences having their sentence weighted scores above a threshold value.
